(19) United States
(12) Patent Application Publication
(10) Pub. No.: US 2008/0121535 A1
(43) Pub. Date: May 29, 2008

(54) Biometric Testing and Monitoring Method and Device

(76) Inventor: Roger K. Cady, Ozark, MO (US)

Correspondence Address: HUSCH BLACKWELL SANDERS LLP, 190 CARONDELET PLAZA, SUITE 600, ST. LOUIS, MO, 63105-3441, US

(21) Appl. No.: 11/862,252

(22) Filed: Sep. 27, 2007

Related U.S. Application Data
(60) Provisional application No. 60/827,350, filed on Sep. 28, 2006.

(51) Int. Cl. G01N 27/26; G01N 27/28

(52) U.S. Cl. 205/792; 204/403.01

(57) ABSTRACT

A biometric testing and monitoring device includes a biosensor with a substrate having an electrical impedance and a coating, at least a first antibody corresponding to at least a first biological marker on said coating, the antibody being operative for binding with the biological marker present in a sample of saliva from a human patient; and a microprocessor in communication with the biosensor and a network. In an alternate embodiment, the device also includes a cognitive testing module in communication with the microprocessor.

### CROSS REFERENCE

This application claims the priority of provisional application Ser. No. 60/827,350, filed Sep. 28, 2006.

### BACKGROUND OF THE INVENTION

The present invention relates generally to the health field and more particularly to an internet-based device and method for testing and monitoring biological markers in humans.

### BACKGROUND OF THE INVENTION

Early identification of disease and pre-disease states is critical to minimization of future disease morbidity and healthcare costs. Presently, there is no system that exists that permits health care consumers to access biological markers of disease and pre-disease conditions that would be essential to making or monitoring lifestyle changes, nutrition changes, or medical interventions. Examples of such disease states are diabetes, cardiovascular disease, and dementia.

The present invention is directed to overcoming one or more of the problems set forth above.

### SUMMARY OF THE INVENTION

One aspect of the invention generally pertains to a consumer device and method that tests and monitors biological markers in human saliva that indicates disease, risk of disease, or response to lifestyle change or therapeutic intervention.

Another aspect of the invention is to provide a consumer-friendly means for monitoring changes in cognitive efficiency.

Yet another aspect of the invention is to provide a system allowing a user to track their current health via biological markers and measurement of cognitive efficiency and readily transmit that data for tracking and analysis to a central server via the internet or a similar communications network.

In one embodiment of the invention, there is provided a biometric testing and monitoring device that includes a biosensor with a substrate having an electrical impedance and a coating, at least a first antibody corresponding to at least a first biological marker on said coating, the antibody being operative for binding with the biological marker present in a sample of saliva from a human patient; and a microprocessor in communication with the biosensor and a network. In an alternate embodiment, the device also includes a cognitive testing module in communication with the microprocessor. The test data produced by the biosensor and cognitive testing module may be communicated to a central server via a network or the internet for analysis.

These aspects are merely illustrative of the innumerable aspects associated with the present invention and should not be deemed as limiting in any manner. These and other aspects, features and advantages of the present invention will become apparent from the following detailed description when taken in conjunction with the referenced drawings.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 is a schematic diagram of a biosensor for a biometric testing device according to one embodiment of the present invention.

FIG. 2 is a schematic view of a cognitive efficiency measurement device for a biometric testing system according to another embodiment.

FIG. 3 is a flow chart illustrating the steps and sequence for measuring cognitive efficiency and change in cognitive efficiency.

### DESCRIPTION OF THE PREFERRED EMBODIMENTS

In the following detailed description numerous specific details are set forth in order to provide a thorough understanding of the invention. However, it will be understood by those skilled in the art that the present invention may be practiced without these specific details. For example, the invention is not limited in scope to the particular type of industry application depicted in the figures. In other instances, well-known methods, procedures, and components have not been described in detail so as not to obscure the present invention.

The overall scope of this undertaking is to provide an internet based system that gives consumers of healthcare information access to biometric testing and interpretation. The user could utilize this information for the purpose of making and monitoring health-related decisions.

In one embodiment, the system is a series of devices that can connect to or be accessed on a desk top computer via the Internet. One device can accept a sample of saliva from which important biological markers such as c-reactive protein, CGRP, endorphins, enkephalins, human growth factors, electrolytes, prostaglandins, and gluten proteins are measured and correlated to serum levels and disease risk and progression. The device can be used to accurately measures changes in these biological markers

The device relies on a method consisting of providing a series of antibodies to several biological markers on a test strip in a known manner, including inflammatory peptides, proteins, human growth factors, endorphins, enkephalins, prostaglandins, and a variety of cytokines. A sample of saliva is collected from a human to be tested and applied to the series of antibodies. If the anticipated biological markers are present in the sample of saliva, those markers bind to their correlating antibodies thereby providing an indicator of the presence and amount of a particular biological marker in the patient's saliva upon evaluation of the test strip. A baseline sample may be taken and compared to subsequent samples in order to determine changes in the levels of specific biological markers in the user over time.

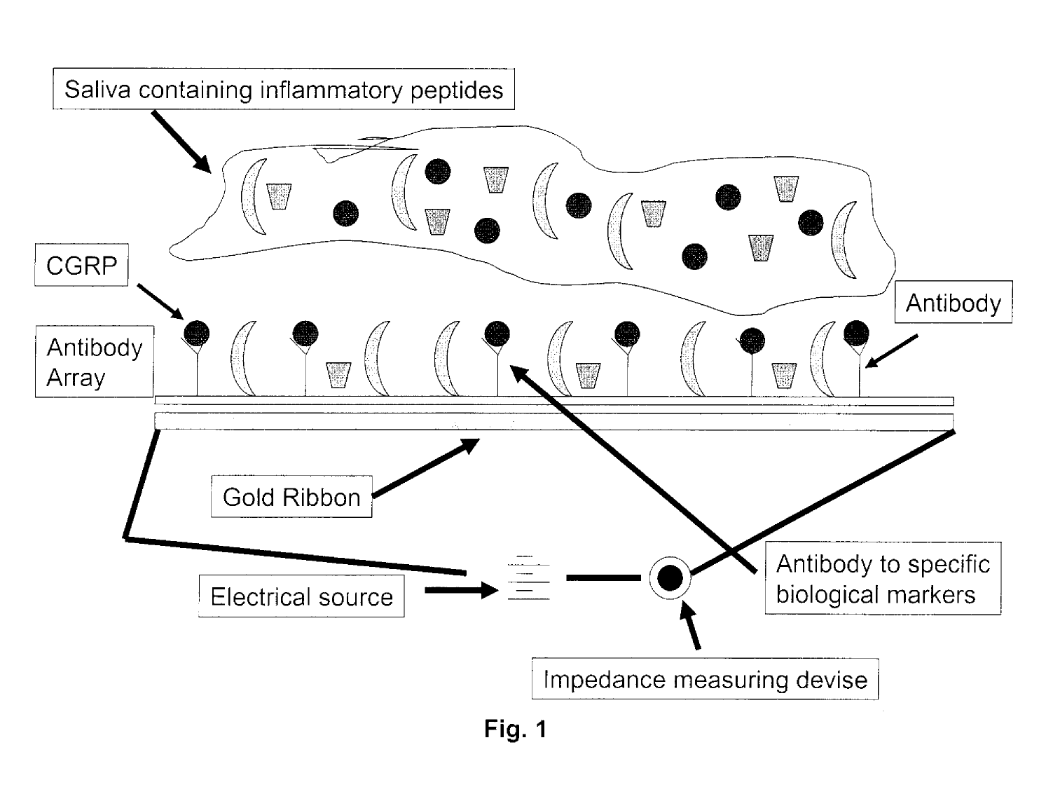

By integration of a biosensor, as schematically illustrated in FIG. 1, an electrical signal is generated that can subsequently be transmitted to other devices, such as a computer. The biosensor consists of a substrate that is coated with D-poly lysine on which antibodies to various biological markers are randomly arranged. In a preferred embodiment, the substrate comprises a gold ribbon. When saliva is applied to the biosensor, a biological marker present in the saliva will bind to its correlating antibody. The interaction of biological marker and antibody alters the electrical impedance of the substrate. This change in impedance can be readily measured and converted into a transmittable electrical signal. It is possible to use various salivatory proteins with this methodology to provide measurement and identification of biological markers critical in diagnosis, staging of disease progression, and treatment of many head and facial pain disorders.

The method described herein can identify, differentiate, diagnose, and stage the progression of disease that involve the release of biological markers such as calcitonin-gene-related peptide, vasoactive intestinal peptide, neurokinin A and B, substance P, c-reactive protein, amylase, IgG, IgA, nitric oxide, prostaglandins, and histamine as a component of the disease process.

A second device can assess mental efficiency and be used as a tool to detect cognitive decline from disease or decline or improvement attributed to medication or lifestyle changes. This information can be used to assist consumers in making health related decisions, monitor the success of these efforts, or monitor medication treatment. The nature of this device is discussed in more detail below.

The Automated Neuropsychological Assessment Metrics (ANAM) is a set of standardized batteries of cognitive tests, modified by neuropsychologists in the U.S. Armed Forces for precise measurement of cognitive processing efficiency of military personnel. The tests assess sustained concentration and attention, mental flexibility, spatial processing, cognitive processing efficiency, mood, arousal/fatigue level, and short-term, long-term and working memory. ANAM is now in the public domain. The most recent version is ANAM V3.11a/96 which includes the following battery of tests:

1. Subject Demographics Form

2. Stanford Sleepiness or Sleep/Fatigue Scale

3. Mood Scale 2

4. Simple and Two-Choice Reaction Time

5. Sternberg Memory Search Tasks

6. Running Memory Continuous Performance Task

7. Mathematical Processing Task

8. Digit Set Comparison Task

9. Logical Reasoning-Symbolic

10. Tower of Hanoi (Tower Puzzle)

11. Stroop Color/Word Interference

12. Code Substitution (Letter/Symbol Comparison)

13. Code Substitution (Immediate and Delayed Recall)

14. Spatial Processing Task (Simultaneous)

15. Matching to Sample

16. Tapping (Left and Right Index Finger)

17. Modified Orientation and Amnesia Test

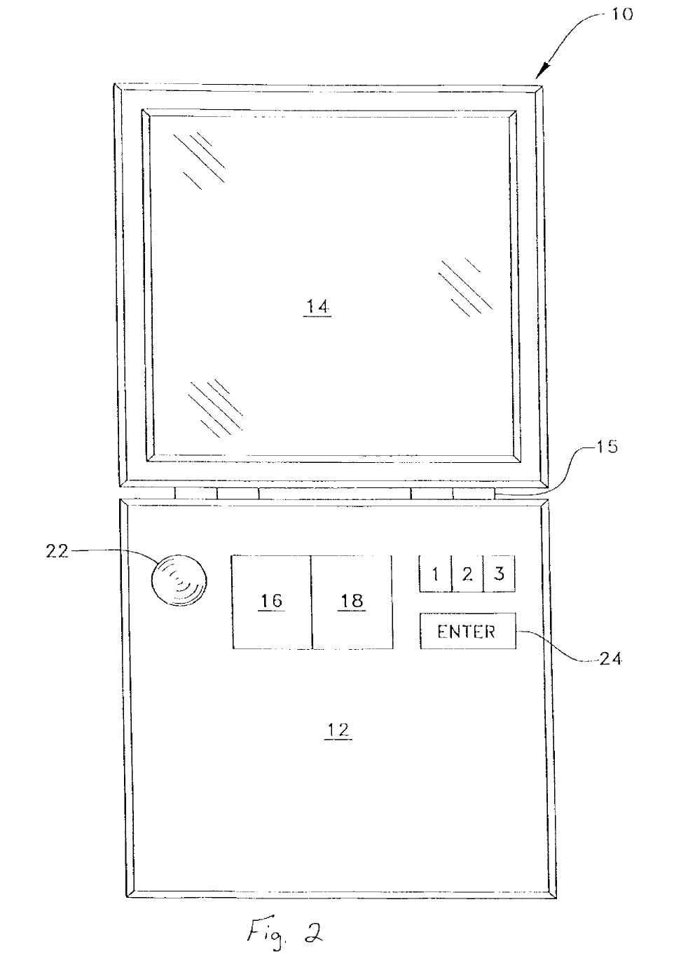

FIG. 2 shows a cognitive efficiency measurement device in the form of a hand-held computer, generally designated 10, and having a key pad 12 and a screen 14 which advantageously is at least four inches (10.16 cm.) square. A hinge 15 is provided so the screen 14 may be conveniently folded down upon the key pad 12 for storage or transporting. The key pad 12 has a built-in set of two mouse buttons 16,18, a start/stop or on/off button 22, an enter key 24, and Mood Scale 2 keys 1, 2 and 3. As used herein the terms “buttons” and “keys” are intended to mean the same thing. The computer 10 contains memory chips (not shown) which have a set of programmed cognitive tests 103-106 (hereafter described) and which record a person's performance time in milliseconds on those tests. An objective standard may be directly entered and stored in the memory chips as a baseline, or a score from a prior battery of tests, converted to stanine, may be used as the baseline. Subsequent trials are similarly scored, converted to stanine, and compared to the baseline. The device 10 can be embodied in a home computer or as a separate device that may communicate with a computer by known means. In either case, results of testing on the device may be analyzed by software loaded on or downloaded to the software or may be uploaded via the internet to a central server for analysis and storage in a database. A similar device and method are disclosed in U.S. Pat. Nos. 6,066,092 and 6,416,472, the disclosures of which are expressly incorporated herein by reference.

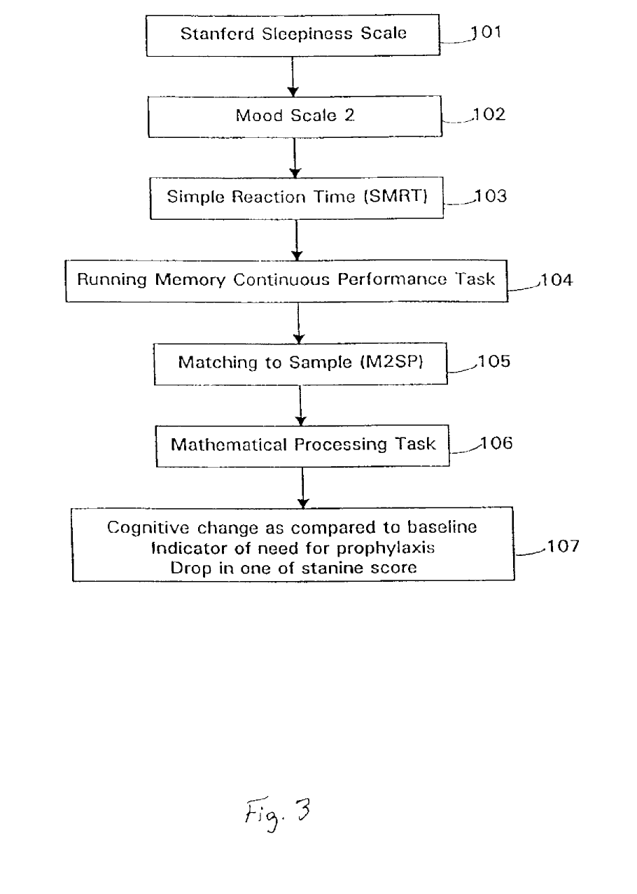

FIG. 3 shows the sequence of a cognitive efficiency measurement method used in the device, as follows:

1. Simple Reaction Time (SMRT), 103

2. Running Memory Continuous Performance Task (CPT), 104

3. Matching to Sample (M2SP), 105

4. Mathematical Processing Task (MATH), 106

In an alternate embodiment only two of the ANAM tests are used in the device:

1. Simple Reaction Time (SMRT), 103

2. Running Memory Continuous Performance Task (CPT), 104

Also included are two preliminary measures of alertness and mood that are also part of the ANAM:

1. Stanford Sleepiness Scale, 101

2. Mood Scale 2, 102.

The first step 101 is Stanford Sleepiness Scale which consists of seven statements that describe the present state of alertness or sleepiness and are numbered from one to seven, with one being highly alert and seven being close to sleep. Individuals rate their level of alertness prior to taking the first subtest of the battery. It provides a way to monitor fatigue over the course of repeated measures. Subjective ratings may be correlated with measured performance.

The second step 102 is Mood Scale 2 which consists of a list of thirty-six adjectives that are rated on a three-point scale. Using mouse button 16 participants respond to each adjective by indicating “yes,” “moderately,” or “no,” based on how they feel at the present time. The Mood Scale 2 categories include anger, happiness, fear (anxiety), depression, activity, and fatigue.

The third step 103 is Simple Reaction Time (SMRT) which presents a simple stimulus on the screen (*). In response, the individual presses the mouse button 16 each time the stimulus appears. The Reaction Time measures the speed of the motor response, the peripheral nerve conduction velocity. This represents the “hardware” of the nervous system in terms of input, followed by motor response. Actual cognitive processing time is not involved in this test.

The fourth step 104 is Running Memory Continuous Performance Test (OPT) which is a continuous letter comparison task. A randomized sequence of upper-case letters, A through Z, is presented one at a time in the center of the computer screen 14. The person presses button 16 if the letter on the screen matches the letter that immediately preceded it; and different button 18 if the letter on the screen is different than the immediately preceding letter. The task lasts approximately five minutes. The CPT was specifically designed to assess components of memory, attention, efficiency and consistency. This task is forced paced, with individuals having only a brief time in which to respond.

The fifth step 105 is Matching to Sample (M2SP) and consists of a number of trials that begins with a first design being presented in the center of the screen 14 for three seconds, followed by a showing that contains two designs. The person matches one of the two designs with the first design or sample by pressing the appropriate button 16 or 18. The design is a 4.times.4 checkerboard and varies by the number of cells that are shaded from one cell through twelve cells.

The sixth step 106 is Mathematical Processing (MATH) and involves arithmetic problems presented in the middle of the screen 14. Working from left to right, the person solves the addition and subtraction and decides if the answer is greater or less than the number 5.

As indicated, the scores are recorded in the memory of the computer 10 and the score on the third trial of these sequenced cognitive tests 103-106 is used as a baseline. As indicated above, a standardized baseline may also be stored in the computer memory. Subsequent trials measure cognitive change as compared to the baseline. An objective standard score or scores received by other tested humans may be directly entered into and stored in the computer as the baseline if it is desired to compare the cognitive efficiency of a human to an objective standard or to other humans.

It will be appreciated by those in the art that the above described tests are purely objective and examine four key areas of cognitive function: reaction time, memory, spatial relationships, and mathematical integration. In addition, the method provides results from these tests almost immediately. The method also allows for the detection of positive or negative change in cognitive efficiency of the user by comparing the most recent test results to an established baseline cognitive efficiency measurement for the test subject.

Various specific aspects of this system include:

1.) A computerized battery of test to test mental efficiency. This test will be scored as a baseline that can be compared to future test results as individual ages, utilizes various medications, or engages in lifestyle changes.

2.) Utilizing biosensor technology, a home device will be available to consumers to measure various biological markers in their salvia. Interpretation will be provided to the consumer.

3.) A computer compatible device that can measure various biological markers in human saliva

4.) A system of computerized tests that determine and monitor mental efficiency

5.) An interactive internet based system that provides medical advice based on the biological markers

6.) A system that personalizes health care information based on a consumers personal history, family history, medical diagnoses, and biological markers

The preferred embodiments of the invention have been described above to explain the principles of the invention and its practical application to thereby enable others skilled in the art to utilize the invention in the best mode known to the inventors. However, as various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by the above-described exemplary embodiment, but should be defined only in accordance with the following claims appended hereto and their equivalents.

I claim:

1. A biometric testing and monitoring device, comprising:
a biosensor comprising a substrate having an electrical impedance and a coating, at least a first antibody corresponding to at least a first biological marker on said coating, said antibody operative for binding with said biological marker present in a sample of saliva from a human patient; and
a microprocessor in communication with said biosensor and a network, said microprocessor operable for accepting an electrical signal from said biosensor and producing test data corresponding to said electrical signal.

2. The biometric testing and monitoring device as set forth in claim 1, wherein said network is a global communication network.

3. The biometric testing and monitoring device as set forth in claim 2, wherein said global communication network is the internet.

4. The biometric testing and monitoring device as set forth in claim 1, wherein said biological marker is selected from the group consisting of inflammatory peptides, proteins, human growth factors, endorphins, enkephalins, prostaglandins, and cytokines.

5. The biometric testing and monitoring device as set forth in claim 1, wherein said biological marker is selected from the group consisting of calcitonin-gene-related peptide, vasoactive intestinal peptide, neurokinin A and B, substance P, c-reactive protein, amylase, IgG, IgA, nitric oxide, prostaglandins, and histamine.

6. The biometric testing and monitoring device as set forth in claim 1, wherein said coating comprises D-poly lysine.

7. The biometric testing and monitoring device as set forth in claim 1, wherein said substrate comprises a gold ribbon.

8. The biometric testing and monitoring device as set forth in claim 1, further comprising a cognitive testing module in communication with said microprocessor.

9. The biometric testing and monitoring device as set forth in claim 8, wherein said cognitive testing module comprises an input device, a display device, a memory, and a cognitive test battery stored in said memory.

10. The biometric testing and monitoring device as set forth in claim 9, wherein said cognitive test battery comprises at least one test from the Automated Neuropsychological Assessment Metrics (ANAM).

11. The biometric testing and monitoring device as set forth in claim 9, wherein said cognitive test battery consists of a Simple Reaction Time test, a Running Memory Continuous Performance test, a Matching to Sample test, and a Mathematical Processing test.

12. The biometric testing and monitoring device as set forth in claim 9, wherein said cognitive test battery consists of a Stanford Sleepiness Scale test and a Mood Scale 2 test, a Simple Reaction Time test, a Running Memory Continuous Performance test, a Matching to Sample test, and a Mathematical Processing test.

13. The biometric testing and monitoring device as set forth in claim 1, further comprising at least a second antibody corresponding to a second biological marker and wherein said first and second antibodies are randomly arranged on said coating.

14. The biometric testing and monitoring device as set forth in claim 1, further comprising a central server in communication with said microprocessor via said network.

15. A biometric testing and monitoring device, comprising:
a biosensor comprising a substrate having an electrical impedance and a coating, at least a first antibody corresponding to at least a first biological marker on said coating, said antibody operative for binding with said biological marker present in a sample of saliva from a human patient;
a microprocessor in communication with said biosensor and a network, said microprocessor operable for accepting an electrical signal from said biosensor and producing test data corresponding to said electrical signal; and
a cognitive testing module in communication with said microprocessor and further comprising an input device, a display device, a memory, and a cognitive test battery stored in said memory.

16. A biometric testing and monitoring device, comprising:
a biosensor comprising a substrate of gold ribbon having an electrical impedance and a coating of D-poly lysine, at least a first antibody corresponding to at least a first biological marker on said coating, said antibody operative for binding with said biological marker present in a sample of saliva from a human patient;
a microprocessor in communication with said biosensor and a global communication network, said microprocessor operable for accepting an electrical signal from said biosensor and producing test data corresponding to said electrical signal;
a cognitive testing module in communication with said microprocessor and further comprising an input device, a display device, a memory, and a cognitive test battery stored in said memory; and
a central server in communication with said microprocessor via said global communication network.

17. A method of testing and monitoring biometrics of a human patient, comprising the steps of:
providing a biosensor comprising a substrate having an electrical impedance and a coating, at least a first antibody corresponding to a first biological marker being arranged on said coating;
applying a sample of saliva from said human patient to said biosensor;
measuring, a change in said electrical impedance of said biosensor substrate resulting from binding of said antibody with said biological marker present in said saliva sample; converting said change in said electrical impedance of said biosensor substrate into a transmittable electrical signal;
transmitting said electrical signal to a microprocessor in communication with said biosensor and a network; and
producing test data in said microprocessor corresponding to said electrical signal.

18. The method of testing and monitoring biometrics as set forth in claim 17, further comprising the steps of:
providing a cognitive testing module in communication with said microprocessor and further comprising an input device, a display device, a memory, and a cognitive test battery stored in said memory; and
conducting at least one cognitive test with said cognitive test battery to produce at least one test result.

19. The method of testing and monitoring biometrics as set forth in claim 18, further comprising the steps of:
providing a central server in communication with said network;
transmitting said test data and said at least one test result to said central server via said network.

20. The method of testing and monitoring biometrics as set forth in claim 17, further comprising the steps of:
providing a central server in communication with said network;
transmitting said test data to said central server via said network.
